(19) United States
(12) Patent Application Publication
(10) Pub. No.: US 2014/0266042 A1
(43) Pub. Date: Sep. 18, 2014

(54) QUICK CHARGE SYSTEM FOR ELECTRIC VEHICLES

(71) Applicant: Contour Hardening, Inc., Indianapolis, IN (US)

(72) Inventor: John M. Storm, Danville, IN (US)

(21) Appl. No.: 13/957,670

(22) Filed: Aug. 2, 2013

Related U.S. Application Data
(60) Provisional application No. 61/788,140, filed on Mar. 15, 2013.

(51) Int. Cl. B60L 11/18

(52) U.S. Cl. CPC B60L 11/1824
USPC 320/109

(57) ABSTRACT

A charging unit for an electric vehicle is disclosed which includes a charging circuit which is constructed and arranged for delivering on a selectable basis one of two Level 3 charges, the selection being made by the user by way of a selection switch. The selection switch being integrated with the corresponding circuitry for selecting either a SAE protocol for charging the electric vehicle or a CHAdeMO protocol for charging the electric vehicle.

### REFERENCE TO RELATED APPLICATIONS

This application claims the benefit of Provisional Patent Application No. 61/788,140, filed Mar. 15, 2013 which is hereby incorporated by reference.

### BACKGROUND

As the number of electric vehicles (EV) becomes a more significant percentage of the automobile landscape, it will become increasingly important to address the technical aspects of EV charging as well as the number of charging stations and charging vehicles which may be available. As the number of electric vehicles increases, it will become more important to have a larger number of EV charging locations, whether as fixed stations or vehicle based, such as charging vehicles with a quick charge (DC) capability. In order to try and avoid situations where the normal traffic flow is adversely affected by a stalled EV due to the loss of charge, quick charge capabilities will be important. Quick charge capabilities will also be important for driver convenience in conjunction with longer trips.

One of the technical factors associated with EVs is which charging standard will be practiced or applicable to the EV which requires charging. EVs will be constructed based on the selected charging standard or protocol and the charging connector of the EV will be compatibly configured. In the US, the Society of Automotive Engineers has established a North American standard, SAE J1772 (i.e. the SAE standard). SAE J1772 is a North American standard for electrical connectors for electric vehicles maintained by the Society of Automotive Engineers and has the formal title “SAE Surface Vehicle Recommended Practice J1772, SAE Electric Vehicle Conductive Charge Coupler”. It covers the general physical, electrical, communication protocol, and performance requirements for the electric vehicle conductive charge system and coupler. The intent is to define a common electric vehicle conductive charging system architecture including operational requirements and the functional and dimensional requirements for the vehicle inlet and mating connector. This standard is important for an EV future and is written to accommodate the latest generation of vehicles that need to be plugged in for charging their high energy batteries. SAE J1772 details the plug configuration, the specifics of the conductive charging interface, the physical interface requirements and the control strategy. This SAE standard may also be identified or referred to as SAE J1772/3.

The connector is designed for single phase electrical systems with 120V or 240V such as those used in North America and Japan. The round 43 mm diameter connector has five pins, with three different pin sizes.
AC Line 1 and AC Line 2/Neutral-Power Pins
Ground Pin-Ground
Proximity Detection-Prevents movement of the car while connected to the charger
Control Pilot-Communication Line used to coordinate charging level between car and the charger as well as other information.
   The connector supports communication over power lines to identify the vehicle and control charging. The connector is designed to withstand up to 10,000 connection/disconnection cycles and exposure to all kinds of elements.

The “rival” CHAdeMO standard is supported by Japanese automakers such as Nissan® and Mitsubishi®. The physical connectors are different shapes and the protocols that control the chargers are different from the SAE standard. As such, each EV has “adopted” a structural configuration which is based on and corresponds to one of these two standards, based on the decision made by the EV manufacturer, likely driven by the country of manufacture.

The CHAdeMO protocol for its quick charger design has a controller that receives EV commands via a CAN bus, and the quick charger sets the current to meet the EV's command value. Via this mechanism, optimal and fast charging becomes possible in response to battery performance and the usage environment.

The CHAdeMO charging sequence is as follows:

1) Preparation for charging

The vehicle checks its compatibility with the charger based on the information transmitted via the CAN bus.

After the connector is locked, the charger applies a short-term voltage load to its exit circuit and conducts a test on the circuit including the connector interface to confirm there are no abnormalities such as a short circuit or ground fault.

2) Start of power supply

After the preparation procedures, the vehicle calculates the current level based on the battery performance and circumstances, which can be charged and sends the value to the charger every 0.1 second through the CAN bus.

The charger supplies an electric current that meets the value from the vehicle via constant current control.

3) End of Charging

The vehicle send zero current signals through CAN bus, and then charger stops its output. After confirmation of zero current on inlet lines of vehicle, EV opens contactor and sends prohibit signal to a charger, and the charger confirms that its output current is zero.

According to the National Electric Code (NEC), charging stations (or charging vehicles) for EVs fall into three distinct Levels (or types). These Levels essentially describe how much power you can supply to the vehicle you are charging, the more power you can deliver, the faster the charge and vice versa. The three Charging Levels as specified by the NEC are the following:

| | Input | Input | Input | | |
|---|---|---|---|---|---|
| | Voltage | Current | Power | | |
| | (VAC) | (Amps) | (kW) | Phase | Standard Outlet |
| Level 1 | 120 | <=16 | <=2 | Single | NEMA 5-15R (Standard |
| | | | | | 110 v outlet for US) |
| Level 2 | 208/240 | <=80 | <=20 | Single | SAE J1772/3 |
| Level 3 | 480 | 125+ | 60+ | Three | Direct Current charge |
| | | | | | in US/Japan |

### Level 1 (120V-AC)

Level 1 uses the “usual” 120-volt, single-phase outlet for a three-prong grounded plug for the US. Although it depends greatly on the vehicle you are charging, it typically takes between 8 to 14 hours to fully charge a vehicle. The biggest advantage to Level 1 is that you can find service almost anywhere in the US and since the charging current is about the same as a standard blow dryer, it will not put too much of a burden on existing electrical service. A disadvantage is the length of time it takes to recharge a vehicle.

### Level 2 (208-230V-AC)

Level 2 increases the charge power by 5× and decreases the typically full charge time down to 4-8 hours, thus the main advantage for Level 2 Charging is speed. The disadvantage of charging something faster is managing the heat that is produced in the battery through the charging process. Although today's EVs are built to manage this heat (using liquid cooling/fans), heat typically shortens battery life.

The Level 1 and 2 charging system consist of an AC/DC converter to generate a DC voltage from the AC line. This incoming power needs to undergo power factor correction (PFC) to boost the power factor to meet regional regulatory standards. At the heart of the inverter is a real-time microcontroller. This controller is programmed to perform the control loops for all necessary power management functions, including AC/DC with PFC and DC/DC to create the necessary charge profile for the battery.

Level 3 (Input: 3 phase 480VAC . . . Output: 300-400VDC)

Level 3 requires very high levels of voltage and current, but the big advantage is speed. Some vehicles can charge in as little as 15 minutes, but it all depends on the battery type and chemistry . . . as charging this fast makes a huge amount of heat that has to be disposed of quickly. Level 3 Charging is perfect for: fleets that need frequent recharges during the day; anyone traveling cross-country trips; and emergency charging in case of evacuation or traffic emergencies.

Unlike Level 1 and 2 chargers which output AC to the vehicle, Level 3 chargers typically output DC using a different plug than the J1772. The CHAdeMO plug specification is used in several Japanese cars including the Nissan Leaf.

The SAE has decided on a J1772 Combo Connector which combines the current J1772 and high power (90 kW) DC charging in one plug. This creates a US Standard for Level 3 and saves automakers from installing two connectors/filler doors on a car.

### SUMMARY

Assuming that both EV charging standards/protocols (SAE and CHAdeMO) remain and assuming that EVs are configured for one or the other of these standards/protocols, additional demands are imposed on EV charging stations and EV charging vehicles. Charging stations/facilities as well as charging vehicles must be configured and equipped to be able to charge any vehicle, whether that vehicle is based on the SAE standard/protocol or that vehicle is based on the CHAdeMO standard/protocol.

Trying to deal with two different EV charging standards complicates the layout and cost of EV charging vehicles and to some extent EV charging stations or facilities. Consider for example, a situation where an EV charging vehicle is responding to a highway or roadway emergency. The typical “emergency” for EV charging is when the EV is stalled and without a sufficient charge on the battery for the EV to be driven. Currently, in order for the EV charging vehicle to be a full-service vehicle it must have both, charging equipment which is based on the SAE standard and charging equipment which is based on the CHAdeMO standard. The duplication of charging equipment on the vehicle in order to have a charging capability for both charging standards represents added cost, added weight and added space requirements as compared to the inventive concept disclosed herein of integrating both types of charging capabilities into a single unit or single item of EV charging equipment.

The present invention is directed to this integration of the two charging standards/protocols into a single unit of charging equipment. By this integration there are both size and weight savings as compared to having two separate and independent EV charging (equipment) units. There are space savings and there may also be savings in terms of the electrical components which are required. The latter depending to some extent on the specific circuitry.

Another aspect which is addressed by the present invention is the level of safety required. If the charging to be performed is based on the SAE standard, then the design of the charging equipment must be such that a CHAdeMO-based charge cannot be delivered to that EV and vice versa. One type of safety “interlock” according to the present disclosure is based on the use of EV charging cables and the corresponding plugs. A safety protocol according to the present invention links together the mechanical deployment of the charging cable (and plug) with the selection of the charging standard. If the SAE standard is selected, then only the SAE cable/plug is able to be deployed and thus plugged into the EV. If the CHAdeMO standard is selected, then only the CHAdeMO cable/plug is able to be deployed and plugged into the EV. This may be achieved by locking the plug in its receiving socket or receptacle or by recoiling and locking the cable.

If a particular cable/plug has already been deployed for charging before selection of the charging standard, the cable/plug is only operable and capable of delivering a charge if the selected charging standard coincides to the already-deployed cable/plug. If these two do not coincide, then an error message is generated and is provided either as an audio signal or visual indication, or both confirming that the deployed cable/plug must be recoiled or otherwise returned to a stowed or an “undeployed” status within the charging equipment, before the error message and its corresponding safety interlock are removed. This warning signal coincides with disabling the charging equipment so that an incorrect charge cannot be delivered. An already deployed cable (i.e. unlocked plug) may be the result of not fully recoiling the cable from a prior charge or may be possible if the cables are not locked when stowed. Another option for having a deployed cable is if the plug is to be locked in its receptacle and it was not returned and fully engaged in its receptacle after a prior charging task. Other features of the integrated charging equipment as disclosed herein and corresponding to the present invention are exemplified by the disclosed embodiment.

### BRIEF DESCRIPTION OF THE DRAWINGS

FIG. 1 is a diagrammatic illustration of an EV charging unit with dual (SAE and CHAdeMO) charging capabilities according to the present disclosure.

FIG. 1A is a diagrammatic illustration of an alternative EV charging unit with dual charging capabilities according to the present disclosure.

FIG. 2 is a schematic illustration and flow diagram of the circuitry for the FIG. 1 EV charging unit.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

Referring to FIG. 1, an EV charging unit 20 is illustrated. Unit 20 is shown in diagrammatic form as a way to better explain the functionality without focusing on the precise mechanical details. What is important is that unit 20 is constructed and arranged to be able to deliver a quick charge (Level 3) based on the SAE charging standard and alternatively (either/or) based on the CHAdeMO charging standard. This “either/or” option is selectable on the EV charging unit 20 (via selection switch 24) depending on the specific EV which is to receive the quick charge and the charging standard which was selected for the manufacture of that EV. The FIG. 1 version of unit 20 is with the charging cables stowed on a recoil mechanism, which is part of interlock mechanism 34, within unit 20. The alternate embodiment of FIG. 1A is essentially the same as EV charging unit 20, though with the charging cables exposed (uncoiled) and the plugs locked when stowed.

The user of unit 20 first determines which charging protocol or standard is required based on the make and model of EV and its specifics in terms of its charging connector. A determination has to be made as to which charging standard was selected by the manufacturer of the EV and that standard dictates which standard is selected on unit 20. If the EV is based on the SAE standard, then the user selects that standard on unit 20 for the EV charging task. If the EV is based on the CHAdeMO standard, then the user selects that standard on unit 20 for the EV charging task. Importantly, unit 20 is electrically configured (see FIG. 2) such that the components and circuitry for both charging standards are integrated into a single unit. By integrating both charging standards into a single unit there are reduced size and weight efficiencies realized by the construction and arrangement of unit 20. There may also be further efficiencies in terms of the number of electrical components which are required, depending on the specific schematic and the specific selection of electrical components.

As for the mechanical configuration of unit 20, the charging circuitry for both standards or protocols is housed within cabinet 22. A selection switch 24 is mounted into a panel 26 of the cabinet 22 and is electrically connected to the remainder of the charging circuitry 28 (see FIG. 2). Unit 20 also includes two separate charging cables 30 and 32, one for each charging standard. Each charging cable is constructed and arranged with a cable length sufficient to extend from unit 20 to the EV. The FIG. 1 style of unit 20 includes a recoil and storage mechanism (not specifically illustrated, but represented by interlock mechanism 34) for each cable. The corresponding plugs are shown and are returned into a corresponding carriage or receptacle at the completion of the prior charging task. Although the respective plugs are not locked in their corresponding carriage or receptacle, neither cable can be extended and deployed until the corresponding recoil and storage mechanism is unlocked. An alternative embodiment for the FIG. 1 charging unit 20 has the charging cables initially unlocked and when a charging selection is made, the non-selected charging cable is locked. The FIG. 1A style of unit 20, identified as unit 120 in FIG. 1A, has the majority of the cables exposed and suspended on the side of the unit with each corresponding plug locked in its receptacle as an alternative to locking the recoiled cables. When the selection is made via selection switch 24, the corresponding plug (SAE or CHAdeMO) is unlocked and able to be removed for charging the EV. An alternative construction begins with each plug unlocked in its receptacle. When a selection is made the “other” plug is locked in position.

Referring to the FIG. 1 embodiment, when not in use the two separate charging cables 30 and 32 are able to be recoiled and stored within unit 20. Each charging cable 30 and 32 includes a corresponding plug 30a and 32a, respectively, which is constructed and arranged, both electrically and mechanically, for compatibility with the charging connector of the EV which is to receive the quick charge. Plug 30a is stowed in receptacle 30b. Plug 32a is stowed in receptacle 32b.

One of the features of the disclosed embodiment is a charging cable mechanical interlock represented diagrammatically by box 34 which surrounds the exit location of the two charging cables 30 and 32. The principle of operation for the interlock mechanism 34 is to prevent extension of whichever charging cable 30, 32 does not coincide with the selected charging standard, via selection switch 24. Each charging cable is constructed and arranged with a storage and recoil mechanism (not illustrated) similar to what may be used on certain electrical devices or appliances, such as a vacuum cleaner. There is spring return to this recoil mechanism allowing the excess cable length to be captured and stowed within unit 20. When a specific charging protocol or standard has been selected, the plug end of the corresponding charging cable is able to be pulled from cabinet 22 and its cable extended (i.e. uncoiled) so as to reach the charging connector of the EV which is to receive the quick charge.

The interlock mechanism 34 is constructed and arranged to unlock the charging cable which coincides with the selected charging protocol. This embodiment is based on each charging cable 30, 32 being locked in place once fully recoiled into a storage condition within cabinet 22. With both charging cables locked in their respective storage conditions, only one can be released or unlocked in order to be extended or uncoiled so as to reach the EV. The one charging cable which is able to be uncoiled and extended is the one charging cable which coincides with the charging protocol or standard which has been selected by the user via selection switch 24. The other charging cable remains coiled and locked. This feature prevents plugging in a CHAdeMO cable to a CHAdeMO based EV with the SAE charging protocol selected. Even if the cable is “right” for the EV, the electrical charge is not.

A design alternative which is contemplated is to reverse the charging cable status. This means that the normal or default status is for each charging cable to be unlocked. Then, when the selection of the desired charging protocol is made via selection switch 24, the “other” non-selected charging cable is locked in its coiled and stowed condition and cannot be extended.

Whichever charging cable and charging unit embodiment is selected, a still further charging cable condition needs to be addressed. This condition is the existence of an extended or partially extended charging cable. A charging cable may be partially extended if it does not fully recoil. An unlocked charging cable may also be partially or fully extended if intentionally extended by the user. The issue is what should occur if the charging standard selection made by the user does not coincide with the charging cable which is partially or fully extended. One concern would be trying to use a charging cable which is not proper for the particular EV. Another concern is trying to deliver a charge protocol which is not correct for the EV even if the cable is correct.

The present invention and the disclosed exemplary embodiment address this issue by including a further safety feature. In the event a charging cable is extended wherein that charging cable does not coincide with the selected charging protocol, charging unit 20 recognizes that the selection and charging cable do not coincide and prevents EV charging until there is a coincidence or correspondence between the extended charging cable and the selected standard or protocol. A warning indication, audio, visual or both, is also provided alerting the user that the extended charging cable and the standard selected do not coincide and that unit 20 is disabled until such time as there is a coincidence or correspondence between the selection and the extended cable.

The disclosed charging circuitry 28 (see FIG. 2) includes the electrical elements and components necessary for the charging cable interlock feature and necessary for the warning indication feature.

In the context of the design variations and alternative embodiments represented by FIGS. 1 and 1A, focusing now solely on the charging cables and corresponding plugs, it is noted that FIG. 1A is likely the closest to currently-configured charging units which would of course have a single cable/plug component. In the context of adding a second cable/plug component for second charging standard/protocol and the desire to have some type of cable/plug interlock, the FIG. 1A arrangement must incorporate any interlock feature relative to the plug when stowed in its cradle or receptacle since the entire length of charging cable is suspended outside of the unit and exposed.

Charging unit 120 as illustrated in FIG. 1A is essentially the same as charging unit 20 in every respect except for the storage and interlock of the cables 130, 132 and their corresponding plugs 130a, 132a. The cable/plug interlock feature for unit 120 focuses on locking each plug 130a and 132a in its corresponding cradle or receptacle 140 and 142, respectively. One design embodiment of unit 120 captures each plug in a locked condition and provides an interlock feature, represented by the broken line outlines 140a and 142a, which unlocks the one plug which coincides with the selected charging standard. The other plug remains locked.

Another design embodiment associated with unit 120 begins with each plug stowed in its corresponding cradle or receptacle in an unlocked condition. When the charging standard selection is made, via selection switch 124, the cable/plug which does not coincide with the charging standard selection is then locked in place. In either embodiment, if a plug is not in its cradle or receptacle when the charging standard selection is made, the warning feature as described for unit 20, is included and fully applicable to the construction and arrangement of unit 120. If the unlocked plug and the charging selection do not coincide, the unit is unable to deliver a charge and an alert of this condition is provided.

Charging units 20 and 120 are constructed and arranged for use as stationary units and are able to be vehicle mounted for use as a mobile charging vehicle.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A charging unit for an electric vehicle comprising:
a charging circuit constructed and arranged for delivering one of two Level 3 charges according to a selected charging protocol; and
selection means for selecting either a SAE protocol for charging the electric vehicle or a CHAdeMO protocol for charging the electric vehicle.

2. The charging unit of claim 1 which further includes a separate charging cable for each charging protocol.

3. The charging unit of claim 2 which further includes charging cable interlock means for locking in a retracted condition the charging cables until a charging protocol selection is made.

4. The charging unit of claim 3 wherein said charging cable interlock means is constructed and arranged to unlock the charging cable which corresponds to the protocol selection.

5. The charging unit of claim 4 which further includes warning means for providing an alert if a charging cable is extended which does not coincide with the charging protocol which is selected.

6. The charging unit of claim 2 which further includes charging cable interlock means for locking in a retracted condition the charging cable for the charging protocol which is not selected.

7. The charging unit of claim 6 which further includes warning means for providing an alert if a charging cable is extended which does not coincide with the charging protocol which is selected.

8. The charging unit of claim 1 which further includes a cabinet which is constructed and arranged to house said charging circuit.

9. The charging unit of claim 8 wherein said selection means includes a selection switch as a part of said cabinet.

10. The charging unit of claim 9 which further includes a separate charging cable for each charging protocol.

11. The charging unit of claim 10 wherein each charging cable includes a charging plug.

12. The charging unit of claim 11 which further includes a pair of receptacles for receiving a corresponding one of said charging plugs.

13. The charging unit of claim 12 which further includes plug interlock means for locking at least one of said charging plugs in its corresponding receptacle.

14. The charging unit of claim 1 wherein said charging unit is constructed and arranged to be a stationary unit.

15. The charging unit of claim 1 wherein said charging unit is constructed and arranged to be part of a mobile charging vehicle.
